(19) United States
(12) Patent Application Publication
(10) Pub. No.: US 2026/0128648 A1
(43) Pub. Date: May 7, 2026

(54) KINETIC ENERGY RECYCLING SYSTEM

(71) Applicant: SOLUTION LEADER TECHNOLOGY CO., LTD., New Taipei City (TW)

(72) Inventor: Deng-Ji LIN, New Taipei City (TW)

(21) Appl. No.: 18/938,292

(22) Filed: Nov. 6, 2024

(51) Int. Cl. H02K 7/18; F03G 3/00; H02K 7/116

(52) U.S. Cl. CPC H02K 7/1853; F03G 3/094; H02K 7/116

(57) ABSTRACT

In the kinetic energy recycling system, a power generation device is driven by a driving device which is in turn powered by a power storage component. A coupling component synchronizes first and second eccentric shafts of the driving device. With the design of the first and second eccentric shafts, gravity and inertia assist in the rotation of the first and second eccentric shafts, reducing the amount of power required from the driving device to operate the power generation device. An acceleration mechanism further improves the power generation efficiency of the power generation device. The generated electrical energy is delivered to a power output component through a conversion device, allowing the user to select the output voltage via the human-machine interface. The energy can be fed back to the power storage component, reducing energy loss, lowering operational noise, and enabling energy recycling for reuse.

### BACKGROUND OF THE INVENTION

### (a) Technical Field of the Invention

The present invention generally relates to power generation, and more particularly to a kinetic energy recycling system that reduces noise, lowers power demand, and enables power regeneration for reuse.

### (b) Description of the Prior Art

A power generation device typically refers to equipment that can convert one form of energy (such as mechanical, thermal, or light energy) into electrical energy. Aside from photovoltaic, thermoelectric, and chemical reactions, most other power generation methods ultimately rely on the principle of electromagnetic induction. This principle involves converting mechanical or other forms of energy into electrical energy by generating an induced electromotive force (EMF) when the rotor and stator move relative to each other, causing a conductor to interact with a magnetic field, which produces current.

The mechanical energy required to move the rotor usually involves continuously applying force to it. After accounting for the frictional losses in various mechanical components, the rotor generates the EMF. In the past, these mechanical losses could only be mitigated through lubrication, but they couldn't be completely eliminated.

Regardless of the power source, a typical power generation device, after producing electrical energy, will generally store it temporarily in a battery or directly supply it to electrical devices. However, the voltage requirements of electrical devices, the voltage output by the battery, and the voltage produced by the power generation device are often different. Simply using a transformer to adjust the voltage can result in significant energy loss or inefficient use of available energy, leading to suboptimal power generation efficiency.

### SUMMARY OF THE INVENTION

A major objective of the present invention is to utilize the solid-hollow symmetrical design of a first eccentric shaft and a second eccentric shaft, which not only reduces noise but also lowers the power demand required for their rotation. This is achieved through the assistance of gravity and inertia, which in turn reduces the energy consumption of the driving device to a power generation device. Alternatively, if the energy consumption of the driving device remains constant, the assistance from gravity and inertia can relatively increase the power output of the power generation device.

Another major objective of the present invention is to integrate the design of the power generation device and the conversion device, allowing the generated electrical energy to be used as a DC power source, an AC power source, or to be recharged back into a power storage component. This extends the power supply duration of the power storage component, enhances overall practicality, and promotes environmental benefits.

To achieve the objectives, a kinetic energy recycling system is disclosed, which includes a driving device, at least one power storage component, a first eccentric shaft including a first solid section and a first hollow section, a second eccentric shaft including a second solid section and a second hollow section, a coupling component, an acceleration mechanism, a power generation device, a conversion device including a rectification module and a transformer module, at least one power output component including at least one DC output unit, at least one AC output unit, and a feedback unit, and a human-machine interface. The driving device operates using power supplied by the power storage component. The first eccentric shaft is connected to the driving device and is driven to rotate by it. The first hollow section and first solid section are symmetrically arranged, defining a first direction extending from the axle of the first eccentric shaft to the center of gravity of the first solid section. The second eccentric shaft is connected to the first eccentric shaft through a coupling component and rotates synchronously with it. The second hollow section and second solid section are symmetrically arranged, defining a second direction extending from the axle of the second eccentric shaft to the center of gravity of the second solid section. The acceleration mechanism is positioned on the side of the second eccentric shaft opposite the first eccentric shaft, and the power generation device is connected to the acceleration mechanism. The conversion device is electrically connected to the power generation device, and the transformer module is located on one side of the rectification module. The power output component is electrically connected to the conversion device, with the AC output unit located next to the DC output unit. The feedback unit is connected to the power storage component, and the human-machine interface is electrically connected to the conversion device.

When the driving device operates using power from the power storage component, it works in conjunction with the coupling component to synchronize the rotation of the first eccentric shaft and second eccentric shaft. Through the design of the first and second solid sections and first and second hollow sections, gravity and inertia assist in the rotation, reducing the amount of power required from the driving device to operate the power generation device. The first and second directions always remain opposite, achieving gravitational balance and preventing additional resistance caused by the weight of the first and second solid sections. Additionally, the acceleration mechanism further improves the power generation efficiency of the power generation device. The generated electrical energy is delivered to the power output component via the rectification module or transformer module of the conversion device. Users can select the output voltage of the DC output unit or AC output unit through the human-machine interface, and part of the energy can be fed back into the power storage component via the feedback unit. This reduces energy loss, lowers operational noise, enables energy recycling, and increases the practicality of the power system.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a kinetic energy recycling system according to a first embodiment of the present invention.

FIG. 2 is a functional block diagram showing the kinetic energy recycling system of FIG. 1.

FIG. 3 depicts the operation scenario of eccentric shafts of the kinetic energy recycling system of FIG. 1.

FIG. 4 depicts the accelerated power generation of the kinetic energy recycling system of FIG. 1.

FIG. 5 is a block diagram showing the operation of the kinetic energy recycling system of FIG. 1.

FIG. 6 is a perspective diagram showing an operation scenario of the kinetic energy recycling system of FIG. 1.

FIG. 7 is a perspective diagram showing a kinetic energy recycling system according to a second embodiment of the present invention.

FIG. 8 is a perspective breakdown diagram showing a kinetic energy recycling system according to a third embodiment of the present invention.

FIG. 9 is a schematic diagram showing an operation scenario of a kinetic energy recycling system according to a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

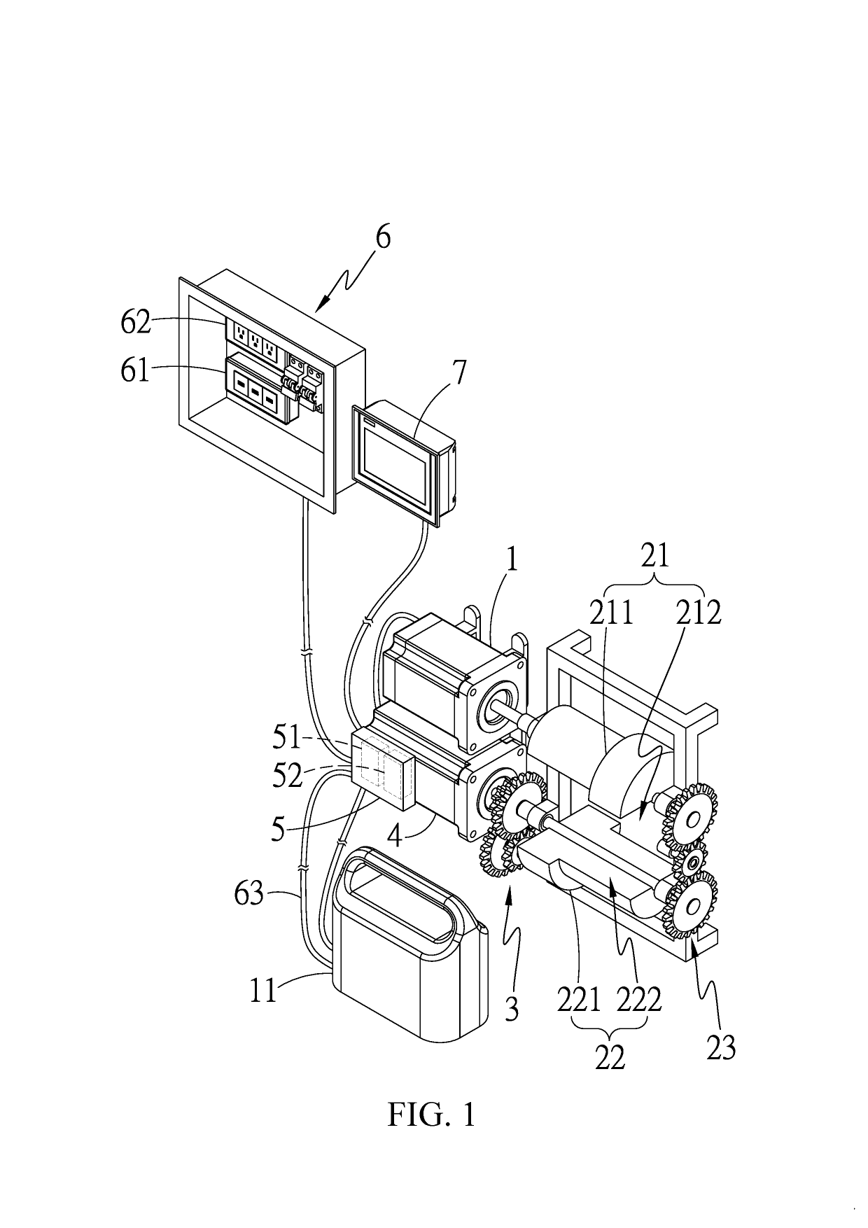

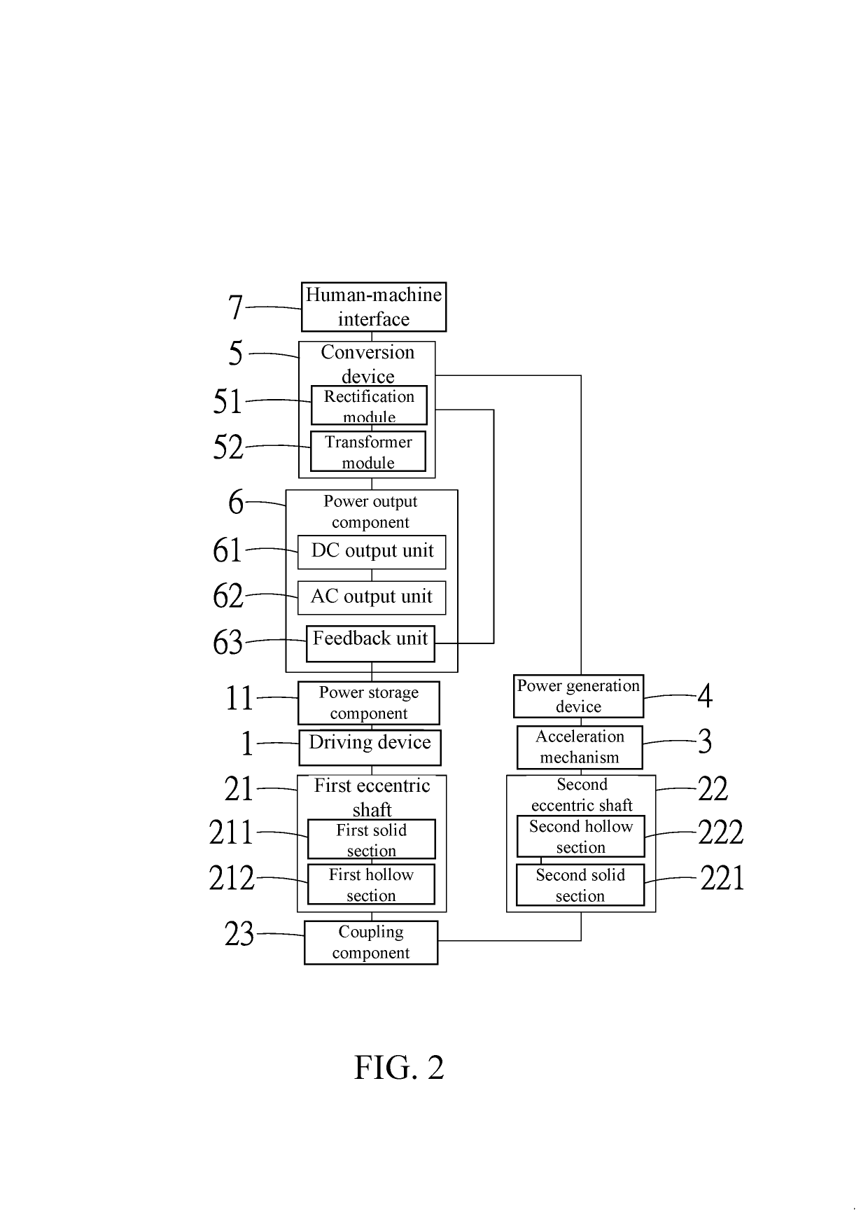

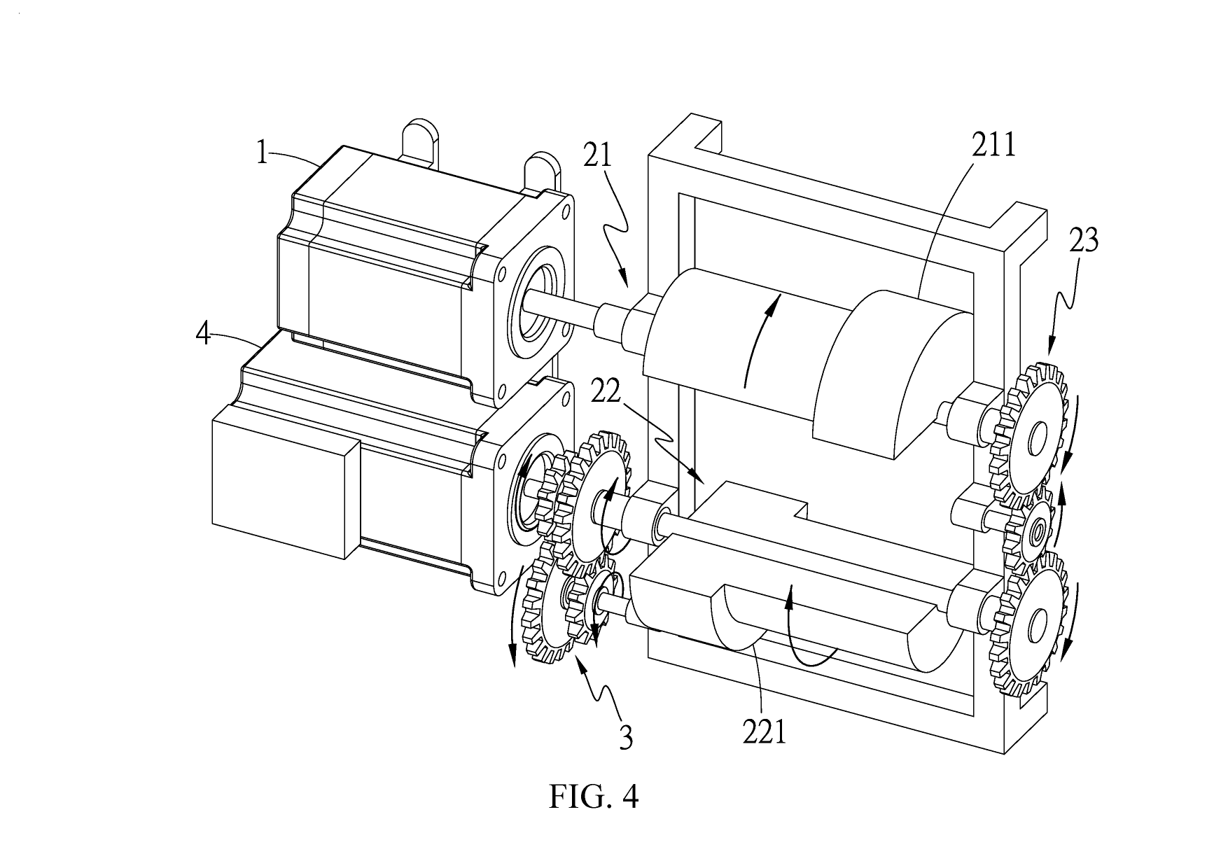

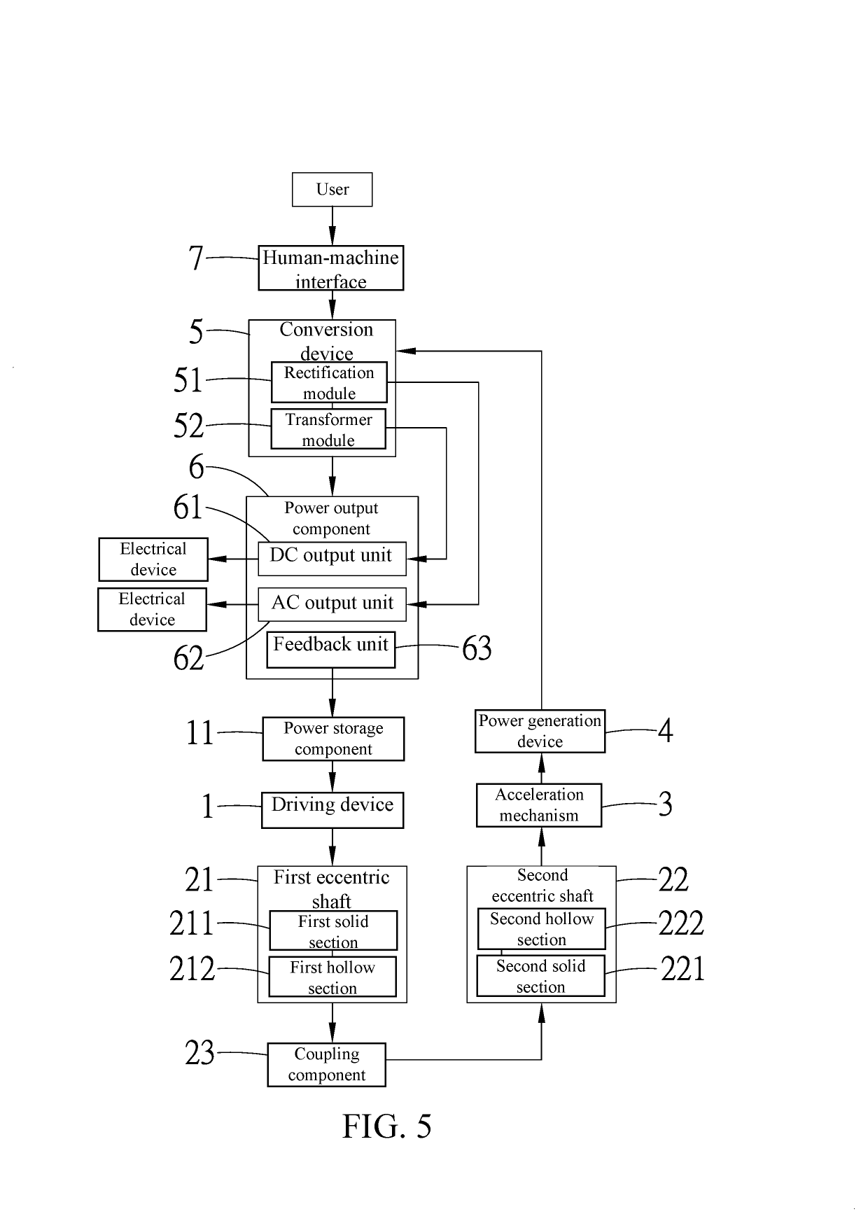

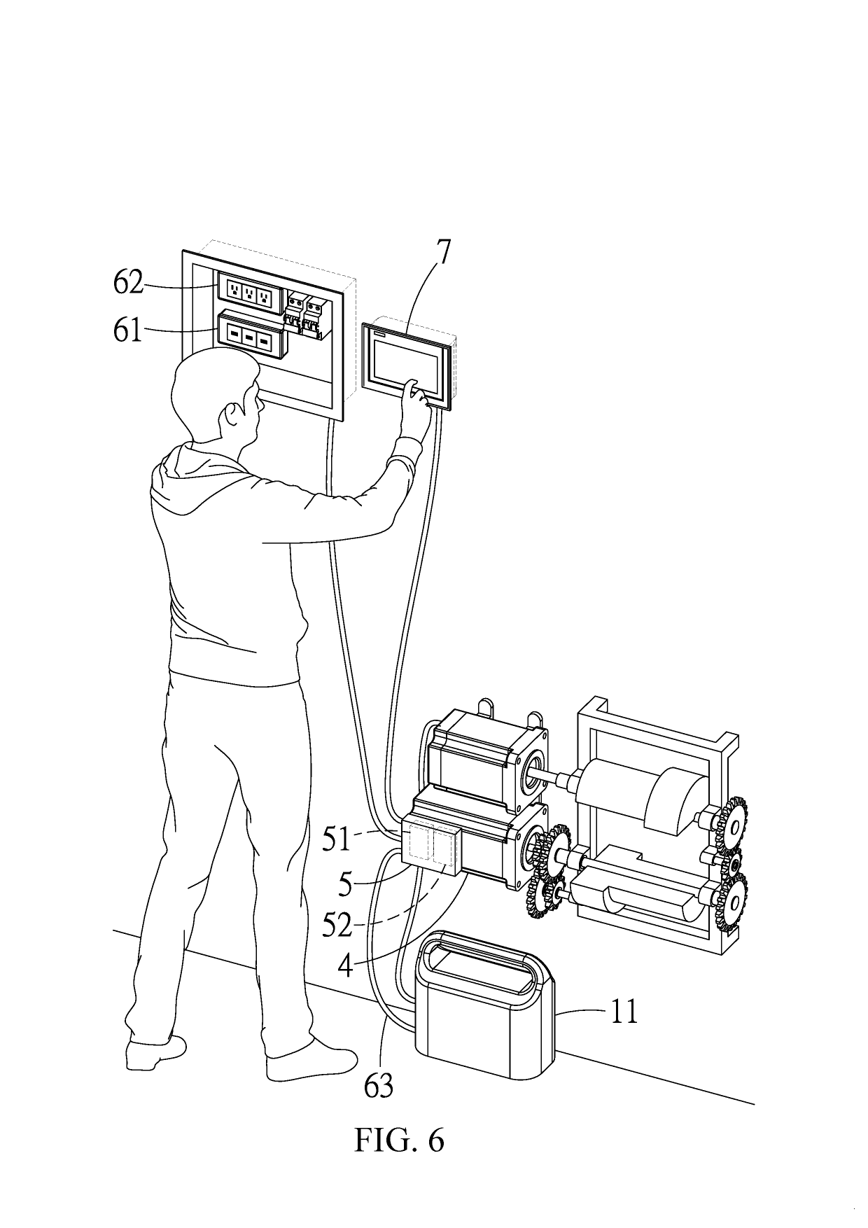

As shown in FIGS. 1 to 6, a kinetic energy recycling system according to a first embodiment of the present invention, includes

a driving device 1 powered by at least one power storage component 11;

a first eccentric shaft 21 connected to and driven to rotate by the driving device 1, where the first eccentric shaft 21 includes a semicylindrical first solid section 211 and a semicylindrical first hollow section 212 joined to an end of the first solid section 211, both mounted on an axle O1, and a first direction is defined by extending from the axle O1 to a center of gravity G1 of the first solid section 211;

a second eccentric shaft 22 connected to the first eccentric shaft 21 through a coupling component 23 so that the second eccentric shaft 22 rotates synchronously with the first eccentric shaft 21, where the second eccentric shaft 22 includes a semicylindrical second solid section 221, and a semicylindrical second hollow section 222 joined to an end of second solid section 221, both mounted on an axle O2, and a second direction is defined by extending from the axle O2 to a center of gravity G2 of the second solid section 221;

an acceleration mechanism 3 connected to and positioned to an end of the second eccentric shaft 22 opposite to the coupling component 23 and to a side of the first eccentric shaft 21;

a power generation device 4 connected to the acceleration mechanism 3, where the power generation device 4’s generation of electricity is assisted through the opposing relationship between the first direction and the second direction;

a conversion device 5 electrically connected to the power generation device 4, which includes a rectification module 51 and a transformer module 52 located on one side of the rectification module 51;

at least one power output component 6 electrically connected to the conversion device 5, which includes at least one DC output unit 61, at least one AC output unit 62 located on one side of the DC output unit 61, and a feedback unit 63 connected to the power storage component 11; and

a human-machine interface 7 electrically connected to the conversion device 5, allowing a user to set the output voltage of the DC output unit 61 or the AC output unit 62.

The driving device 1 may be a DC motor or an AC motor, and the power storage component 11 is a rechargeable battery, which may be a portable battery (or battery pack), a home energy storage system, or an industrial/commercial energy storage cabinet. In the present embodiment, a high-power backup power source for a home energy storage system is used as an example. The first eccentric shaft 21 and the second eccentric shaft 22 are structures where the centers of gravity G1 and G2 are offset from the axles O1 and O2, but the axles O1 and O2 remain coaxial with their respective driving sources. Thus, in the present embodiment, the first solid section 211 and second solid section 221 have a solid semicylindrical shape, while the first hollow section 212 and second hollow section 222 are hollow semicylindrical structures or spaces corresponding to the first solid section 211 and second solid section 221. In the present embodiment, the first solid section 211 and first hollow section 212 are defined and integrally formed within the first eccentric shaft 21, and the second solid section 221 and second hollow section 222 are defined and integrally formed within the second eccentric shaft 22. The coupling component 23 is one of a gear set, pulley set, or sprocket set, with the gear set used as an example in this embodiment. The acceleration mechanism 3 is also one of a gear set, pulley set, or sprocket set, and again, the gear set is used as an example in this embodiment. The power generation device 4 is either a DC generator or an AC generator based on the principle of electromagnetic induction using multiple magnetic elements and coils. Since magnetic elements and coils are well-known in power generation, they are not elaborated or illustrated. The conversion device 5 is exemplified by a circuit board, where the rectification module 51 is a rectifier or inverter, and the transformer module 52 is exemplified by a transformer. Both the rectification module 51 and the transformer module 52 are mounted on the circuit board of the conversion device 5, shown schematically in the drawing with a dashed-line frame. The DC output unit 61 is exemplified by DC sockets or USB sockets, while the AC output unit 62 is exemplified by AC sockets. The feedback unit 63 is exemplified by a power transmission cable. The human-machine interface 7 is exemplified by an operating panel. However, the types of components mentioned above are merely examples of a preferred embodiment, and any components with similar functions are within the scope of the present invention and are not limited to the examples provided.

In practical use, the driving device 1, first eccentric shaft 21, second eccentric shaft 22, acceleration mechanism 3, power generation device 4, and conversion device 5 can be installed on a wall or floor, or embedded in a groove on the wall or floor. The driving device 1 and feedback unit 63 are connected to the power storage component 11, and the conversion device 5 is connected to the power output component 6. When the driving device 1 operates using power from the power storage component 11, it rotates the first eccentric shaft 21 coaxially. Through the design of the coupling component 23, the first eccentric shaft 21 and second eccentric shaft 22 rotate synchronously in both speed and direction. In this embodiment, the coupling component 23 consists of three gears. The gears on the sides of the first eccentric shaft 21 and the second eccentric shaft 22 have the same specifications, while the middle gear is an idler, used only to adjust the distance or transmission path between the other two gears without altering their speed or direction. In this embodiment, the first eccentric shaft 21 and the second eccentric shaft 22 are arranged in a vertically parallel configuration, but this is not a strict requirement. Through the design of the coupling component 23, the positional relationship between the first eccentric shaft 21 and the second eccentric shaft 22 can be adjusted, preventing excessive lengthening of the overall structure, making it easier to install in a rectangular space with a near-equal length-to-width ratio.

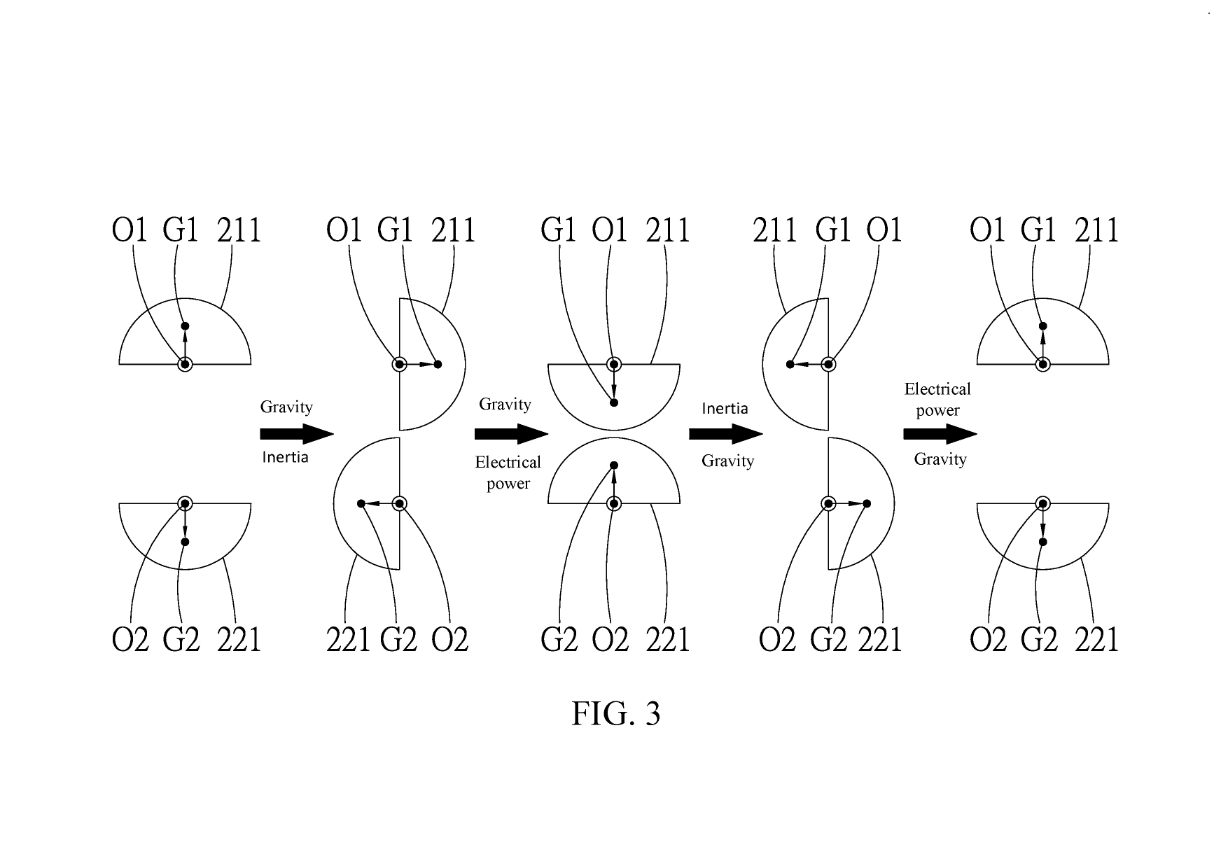

When the first eccentric shaft 21 and the second eccentric shaft 22 rotate, due to the design of the first solid section 211, second solid section 221, first hollow section 212, and second hollow section 222, the centers of gravity G1 and G2 of the first and second eccentric shafts 21 and 22 are radially displaced. This displacement of the centers of gravity G1 and G2 creates a rotational torque on their respective axles O1 and O2 due to gravity. As shown in FIG. 3, the top row illustrates the continuous motion of the first solid section 211 as it rotates clockwise by 90 degrees each time, and the bottom row shows the continuous motion of the second solid section 221, also rotating clockwise by 90 degrees. The arrows marked on the first solid section 211 and the second solid section 221 indicate the first and second directions at each rotational position. The annotations next to the arrows between each stage of motion in the top and bottom rows represent the power sources used during the rotation process. For example, when the center of gravity G1 of the first solid section 211 is above its axle O1, gravity causes the center of gravity G1 to swing downward to below axle O1. It can then continue to swing to the left of axle O1 with the momentum generated by the swing. In the diagram, the vertically aligned first solid section 211 and second solid section 221 are depicted in their respective states at the same time. Therefore, gravity and inertia respectively assist in the rotation of the first eccentric shaft 21 and the second eccentric shaft 22. The mechanical force generated by the rotation of the first and second eccentric shafts 21 and 22, driven by gravity and inertia, helps power the power generation device 4. Only when the momentum generated by inertia is used up (when the centers of gravity G1 and G2 are on the left side of axles O1 and O2) and before the centers of gravity G1 and G2 move back above axles O1 and O2, does the driving device 1 (electric power) need to assist in driving the rotation. This reduces the amount of electrical power required from the driving device 1 to operate the power generation device 4.

Since the first eccentric shaft 21 and the second eccentric shaft 22 rotate synchronously, and the first direction and second direction always remain opposite, this means that when the center of gravity G1 of the first solid section 211 is above the axle O1 of the first eccentric shaft 21 (with the first direction pointing upward), the center of gravity G2 of the second solid section 221 will be below the axle O2 of the second eccentric shaft 22 (with the second direction pointing downward). Alternatively, when the offset center of gravity G1 of the first solid section 211 is to the left of the axle O1 of the first eccentric shaft 21 (with the first direction pointing left), the offset center of gravity G2 of the second solid section 221 will be to the right of the axle O2 of the second eccentric shaft 22 (with the second direction pointing right). Thus, since at least one of the eccentric shafts—either the first eccentric shaft 21 or the second eccentric shaft 22—always generates rotational assistance, the driving device 1 can continuously receive operational power support. From another perspective, if the driving device 1 outputs at a constant frequency without reducing output power due to the assistance from the first and second eccentric shafts 21 and 22, the rotational assistance gained from the first eccentric shaft 21 and the second eccentric shaft 22 can relatively increase the rotational speed of the power generation device 4 (increasing the rotor's rotational speed), potentially enhancing the power generation efficiency. Moreover, the torque generated by the first solid section 211 when it is to the left (or right) of the axle O1 of the first eccentric shaft 21 is equal in magnitude but opposite in direction to the torque generated by the second solid section 221 when it is to the right (or left) of the axle O2 of the second eccentric shaft 22. This achieves a clever gravitational balance, preventing additional resistance caused by the weight of the first solid section 211 and second solid section 221, thereby avoiding the noise that could be generated from this resistance during operation.

Additionally, the acceleration mechanism 3 is configured between the second eccentric shaft 22 and the power generation device 4 which, in this embodiment, is a gear set. Specifically, a first large gear is coaxially mounted on one side of the second eccentric shaft 22. This first large gear meshes with a first small gear, which is coaxially mounted with a second large gear. The second large gear meshes with a second small gear, which is connected to the power generation device 4 and is also coaxially mounted with it. In this way, the power generation device 4 can be accelerated in two stages through the acceleration mechanism 3. According to Faraday's law, the induced electromotive force is proportional to the rate of change in the magnetic field. This means that the faster the change in the magnetic field (such as a faster rotor rotation), the greater the magnetic flux and the higher the induced electromotive force, leading to increased power generation. Therefore, the acceleration mechanism 3 can further improve the power generation efficiency of the power generation device 4.

The generated electrical energy is delivered to the power output component 6 through the rectification module 51 or transformer module 52 of the conversion device 5. In this embodiment, the power generation device 4 is a DC power generation system, and the rectification module 51 is an inverter. Therefore, the electrical energy produced by the power generation device 4 can be output directly as DC at the required voltage via the transformer module 52, or it can be converted by the inverter and output as AC at the required voltage. This allows the user to select the output voltage of the DC output unit 61 or the AC output unit 62 through the human-machine interface 7, and then connect to corresponding electrical devices. For example, the user can choose 110V, 220V, or 380V AC, in which case there would be three AC output units 62, providing different voltages according to the user's settings for greater flexibility. The same applies to the DC output unit 61, which works similarly and will not be elaborated further. Additionally, the feedback unit 63 can store part of the electrical energy produced by the power generation device 4 back into the power storage component 11, thereby reducing energy loss, enabling energy recycling and reuse, extending the power supply duration of the power storage component 11, and enhancing the practicality of the power system.

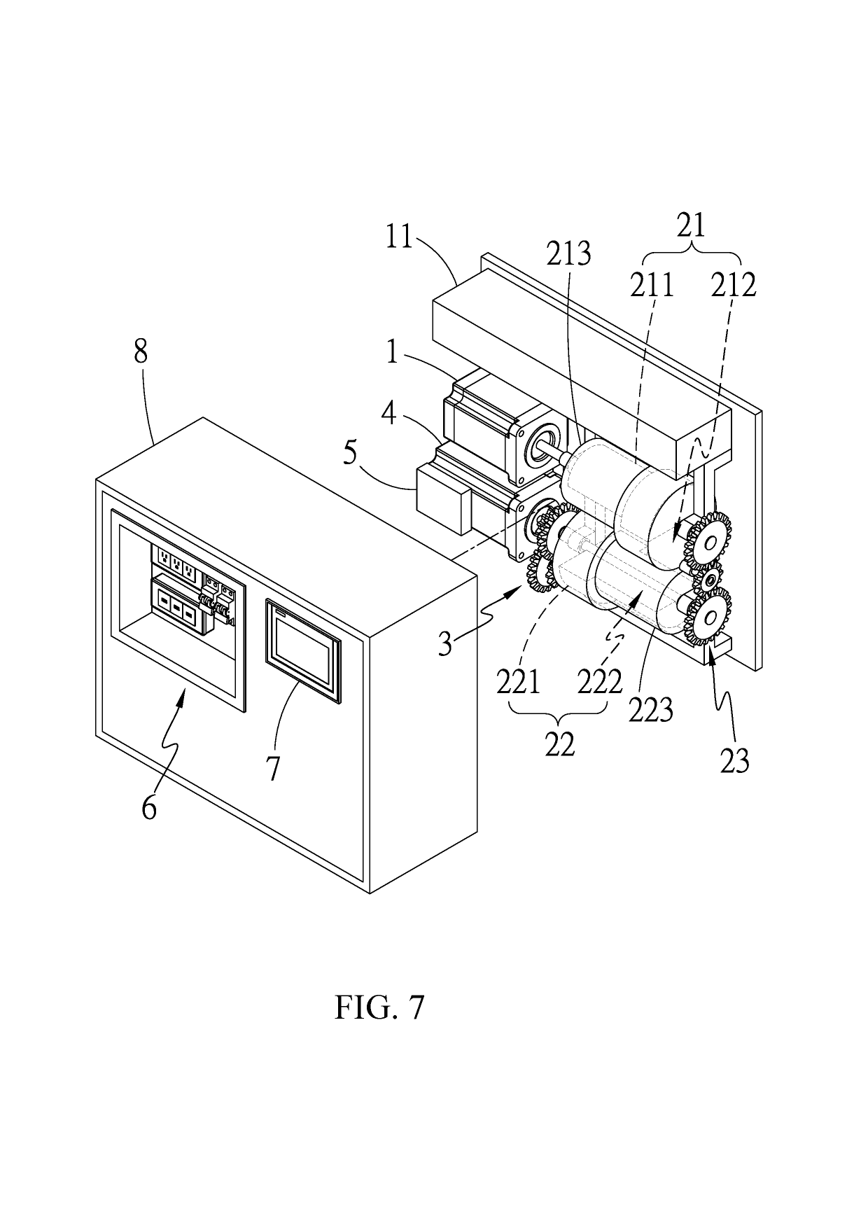

As shown in FIG. 7, a second embodiment of the present invention is similar to the previous embodiment, except that it further includes a case 8. The driving device 1, power storage component 11, first eccentric shaft 21, coupling component 23, second eccentric shaft 22, acceleration mechanism 3, power generation device 4, and conversion device 5 are all housed inside the case 8, while the power output component 6 and human-machine interface 7 are installed on a front side of the case 8. A first housing 213 encloses the first solid section 211 and first hollow section 212, and/or a second housing 223 encloses the second solid section 221 and second hollow section 222. This means that the first housing 213 and second housing 223 can be used individually or simultaneously. The case 8 can be a box that encloses the related components, with the power output component 6 and human-machine interface 7 positioned on the front side of the case 8 for ease of user setup and connection, transforming the overall structure into a portable design. Additionally, the first housing 213 and second housing 223 enclose the first eccentric shaft 21 and second eccentric shaft 22, respectively. This not only reduces the accumulation of dirt and dust on the first solid section 211 and second solid section 221, but also provides collision protection and enhances the structural strength of the first and second eccentric shafts 21 and 22. Alternatively, the first housing 213 can be designed integrally with the first solid section 211, where the hollow portion inside the first housing 213 would function as the first hollow section 212. The second housing 223 can be designed similarly.

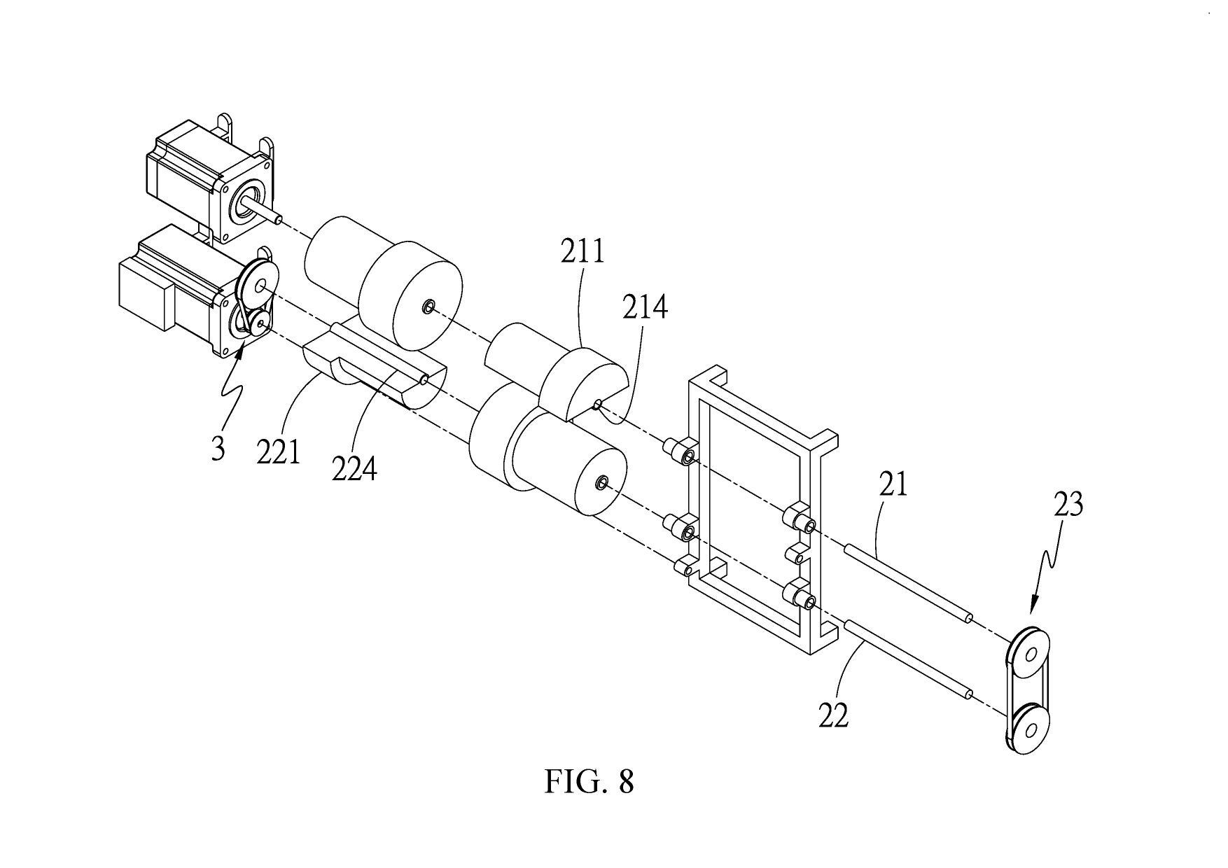

As shown in FIG. 8, a third embodiment of the present invention is similar to the previous one, except that the first solid section 211 includes a first shaft connector 214, which is fixed to the first eccentric shaft 21, and/or the second solid section 221 includes a second shaft connector 224, which is fixed to the second eccentric shaft 22. This means that the first shaft connector 214 and the second shaft connector 224 can be used individually or together. Additionally, in this embodiment, the coupling component 23 and/or the acceleration mechanism 3 are modified to use a pulley assembly instead, though the function and effects remain the same. The design can be freely changed according to the designer's needs, demonstrating that the coupling component 23 and the acceleration mechanism 3 are not limited to any specific form. The first shaft connector 214 and the second shaft connector 224 are respectively fixed or integrated onto the axles of the first solid section 211 and the second solid section 221. In this embodiment, they are fixed using a sleeve structure and secured with locking mechanisms like latches or pins to the first eccentric shaft 21 and the second eccentric shaft 22. This way, it is only necessary to manufacture the first solid section 211 and the second solid section 221 and fix them to the first eccentric shaft 21 and the second eccentric shaft 22 using the first shaft connector 214 and the second shaft connector 224. This simplifies the manufacturing process and makes the cleaning and replacement of the first and second eccentric shafts 21 and 22 easier.

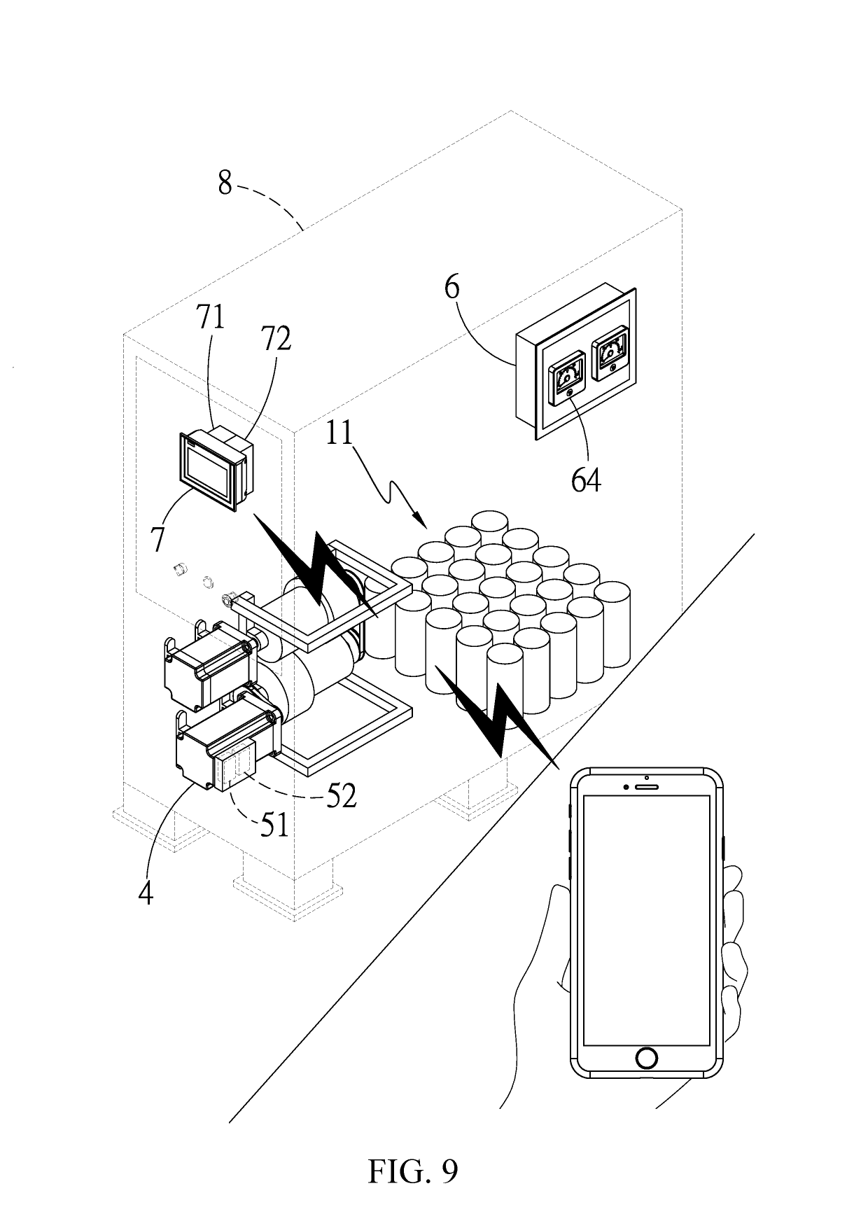

As shown in FIG. 9, a fourth embodiment of the present invention is similar to the previous embodiments except that the human-machine interface 7 includes a wireless connection module 71 for connecting to an electronic device via a network, and a battery management module 72 electrically connected to the power storage component 11. Additionally, on one side of the power output component 6, there is at least one detection and display device 64, which monitors and displays the electrical characteristics of the power output component 6. In this embodiment, the power storage component 11 is exemplified by a large energy storage cabinet composed of multiple batteries, housed in the case 8. Besides the human-machine interface 7, the case 8 can also be equipped with ammeters, voltmeters, and other devices to monitor and display the current electrical characteristics, allowing the user to intuitively view the power usage status through the detection and display device 64. Additionally, the wireless connection module 71 allows for remote connection to the human-machine interface 7, enabling users to set and monitor the system directly from an electronic device. At the same time, the battery management module 72 can connect to the various power storage components 11 to ensure safe monitoring and performance management of all power storage components 11. Furthermore, in this embodiment, the power generation device 4 is an AC power generation system, so the rectification module 51 is a rectifier. Thus, the electrical energy produced by the power generation device 4 can be output directly as AC at the required voltage via the transformer module 52, or it can be converted by the rectifier and output as DC at the required voltage.

While certain novel features of this invention have been shown and described and are pointedut in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A kinetic energy recycling system, comprising:
a driving device powered by at least one power storage component;
a first eccentric shaft connected to and driven to rotate by the driving device, where the first eccentric shaft comprises a first solid section and a first hollow section joined to an end of the first solid section, both mounted on a first axle, and a first direction is defined by extending from the first axle to a center of gravity of the first solid section;
a second eccentric shaft connected to the first eccentric shaft through a coupling component so that the second eccentric shaft rotates synchronously with the first eccentric shaft, where the second eccentric shaft comprises a second solid section, and a second hollow section joined to an end of the second solid section, both mounted on a second axle, and a second direction is defined by extending from the second axle to a center of gravity of the second solid section;
an acceleration mechanism connected to and positioned to an end of the second eccentric shaft opposite to the coupling component and to a side of the first eccentric shaft;
a power generation device connected to the acceleration mechanism, where the power generation device’s generation of electricity is assisted through an opposing relationship between the first direction and the second direction;
a conversion device electrically connected to the power generation device, which comprises a rectification module and a transformer module located on one side of the rectification module;
at least one power output component electrically connected to the conversion device, which comprises at least one DC output unit, at least one AC output unit located on one side of the DC output unit, and a feedback unit connected to the at least one power storage component; and
a human-machine interface electrically connected to the conversion device, allowing a user to set the output voltage of the at least one DC output unit or the at least one AC output unit.

2. The kinetic energy recycling system according to claim 1, wherein the first solid section and first hollow section are integrally formed within the first eccentric shaft, and/or the second solid section and second hollow section are integrally formed within the second eccentric shaft.

3. The kinetic energy recycling system according to claim 1, wherein the first solid section comprises a first shaft connector, which is fixed to the first eccentric shaft.

4. The kinetic energy recycling system according to claim 1, wherein the second solid section comprises a second shaft connector, which is fixed to the second eccentric shaft.

5. The kinetic energy recycling system according to claim 2, wherein the first eccentric shaft further comprises a first housing enclosing the first solid section and first hollow section.

6. The kinetic energy recycling system according to claim 3, wherein the first eccentric shaft further comprises a first housing enclosing the first solid section and first hollow section.

7. The kinetic energy recycling system according to claim 4, wherein the first eccentric shaft further comprises a first housing enclosing the first solid section and first hollow section.

8. The kinetic energy recycling system according to claim 2, wherein the second eccentric shaft further comprises a second housing enclosing the second solid section and second hollow section.

9. The kinetic energy recycling system according to claim 3, wherein the second eccentric shaft further comprises a second housing enclosing the second solid section and second hollow section.

10. The kinetic energy recycling system according to claim 4, wherein the second eccentric shaft further comprises a second housing enclosing the second solid section and second hollow section.

11. The kinetic energy recycling system according to claim 1, wherein the human-machine interface further comprises a battery management module electrically connected to the at least one power storage component.

12. The kinetic energy recycling system according to claim 1, wherein the human-machine interface further comprises a wireless connection module for connecting to an electronic device via a network.

13. The kinetic energy recycling system according to claim 1, wherein the at least one power output component further comprises at least one detection and display device, which monitors and displays electrical characteristics of the at least one power output component.

14. The kinetic energy recycling system according to claim 1, further comprising a case where the driving device, at least one power storage component, first eccentric shaft, coupling component, second eccentric shaft, acceleration mechanism, power generation device, and conversion device are all housed inside the case, while the at least one power output component and human-machine interface are installed on a front side of the case.
